(19) United States
(12) Patent Application Publication
(10) Pub. No.: US 2011/0046795 A1
(43) Pub. Date: Feb. 24, 2011

(54) DRIVE CONTROL METHOD, DRIVE CONTROL APPARATUS, STAGE CONTROL METHOD, STAGE CONTROL APPARATUS, EXPOSURE METHOD, EXPOSURE APPARATUS AND MEASURING APPARATUS

(75) Inventors: Hiroshi Fujimoto, Kashiwa-shi (JP); Koichi Sakata, Nagareyama-shi (JP); Kazuaki Saiki, Yokohama-city (JP); Takeshi Ohtomo, Yokohama-city (JP)

Correspondence Address: OLIFF & BERRIDGE, PLC, P.O. BOX 320850, ALEXANDRIA, VA, 22320-4850, US

(73) Assignees: NATIONAL UNIVERSITY CORPORATION YOKOHAMA NATIONAL UNIVERSITY, Yokohama-Shi (JP); NIKON CORPORATION, Tokyo (JP)

(21) Appl. No.: 12/719,457

(22) Filed: Mar. 8, 2010

Related U.S. Application Data
(63) Continuation of application No. PCT/JP2008/066086, filed on Sep. 5, 2008.

(30) Foreign Application Priority Data
Sep. 7, 2007 (JP) 2007-233325

(51) Int. Cl. G01M 1/38

(52) U.S. Cl. 700/280

(57) ABSTRACT

A drive control method of controlling an object which can move at least in a first direction and a second direction different from the first direction is provided. Here, a force applied to the object is controlled on the basis of a driving signal for driving a first actuator moving the object in the first direction and a disturbance correcting signal generated from a disturbance signal in the second direction at an output terminal of the object.

### CROSS-REFERENCE TO RELATED APPLICATION

This is a Continuation Application of International Application No. PCT/JP2008/066086, filed Sep. 5, 2008, which claims priority to Japanese Patent Application No. 2007-233325, filed on Sep. 7, 2007, the contents of which are incorporated herein by reference.

### BACKGROUND

1. Field of the Invention

The present invention relates to a drive control method, a drive control apparatus, a stage control method, a stage control apparatus, an exposure method, an exposure apparatus, and a measuring apparatus.

2. Description of Related Art

So far, in the process of manufacturing a liquid crystal display (generically referred to as “flat panel display”), an exposure apparatus has often been used to form elements such as transistors or diodes on a plate (glass plate). In the exposure apparatus, a plate to which a resist is applied is placed on a holder of a stage device and a fine circuit pattern drawn on a mask is transferred to the plate through an optical system of a projection lens or the like. Recently, for example, a step-and-scan type exposure apparatus has been increasingly used (for example, see JP-A-2000-077313).

The step-and-scan type exposure apparatus is an exposure apparatus sequentially transferring a part of a pattern formed on a mask onto a shot area of a plate while synchronously moving the mask and the plate relative to a projection optical system in a state where the mask is irradiated with slit-like exposing light, moving the plate step by step when the transfer of the pattern onto one shot area is finished, and transferring the pattern onto another shot area.

When an exposure process is performed on plural partitioned areas (shot areas) set on the surface of a plate, it is necessary to move the plate and the mask at an almost constant speed which is a speed suitable for an exposing dose while synchronizing the positions of the plate and the mask. Accordingly, a procedure of running up (accelerating) a plate stage mounted with the plate and a mask stage mounted with the mask, synchronizing the stages during the running, and irradiating an exposure area with the exposing light to expose the plate when the shot area as an exposure target on the plate reaches the exposure area (exposure position) is carried out.

A mechanism (focal position detector or the like) is provided which measures a distance between a lens of the projection optical system and the plate, for example, using a sensor or the like and performing an automatic focusing operation by feedback control, so as to maintain a just-focused state (where the imaging point of the projection optical system PL is matched with the position in the Z direction of the exposure area on the plate) based on the projection optical system at the time of irradiating the exposure area with the exposing light.

Recently, the exposure area has increased in size and the stage has also increased in size. However, when a large-sized stage is accelerated, the stage easily vibrates and the vibration remains even after the accelerated stage reaches a constant speed. Accordingly, the auto focusing operation may not be satisfactory and it may be difficult to maintain the just-focused state. The problem with the vibration of the stage is not limited to the exposure apparatus, but is considered as true in other systems including a moving object such as a stage.

### SUMMARY

An advantage of some aspects of the invention is that it provides a drive control method, a drive control apparatus, a stage control method, a stage control apparatus, an exposure method, an exposure apparatus, and a measuring apparatus, which can satisfactorily suppress vibration of an object to be driven.

According to a first aspect of the invention, there is provided a drive control method of controlling an object which can move in at least a first direction and a second direction different from the first direction, wherein a force applied to the object is controlled on the basis of a driving signal for driving a first actuator moving the object in the first direction and a disturbance correcting signal generated from a disturbance signal in the second direction at the output terminal of the object.

According to the first aspect, since the force applied to the object is controlled on the basis of the disturbance correcting signal generated from the disturbance in the second direction of the object in addition to the driving signal for driving the first actuator moving the object in the first direction, it is possible to prevent the adverse effect of the disturbance at the output terminal generated after accelerating the object in the first direction.

According to a second aspect of the invention, there is provided a drive control apparatus for controlling an object which can move in at least a first direction and a second direction different from the first direction, including: a signal generator that generates a driving signal for driving a first actuator moving the object in the first direction and a disturbance correcting signal generated on the basis of a disturbance in the second direction of the object; and a controller that controls a force applied to the object on the basis of the driving signal and the disturbance correcting signal.

According to the second aspect, since the force applied to the object is controlled on the basis of the disturbance correcting signal generated from the disturbance in the second direction of the object in addition to the driving signal for driving the first actuator moving the object in the first direction, it is possible to prevent the adverse effect of the disturbance at the output terminal generated after accelerating the object in the first direction.

According to a third aspect of the invention, there is provided a stage control method of controlling a stage which can move in at least a first direction and a second direction different from the first direction, wherein a force applied to the stage is controlled on the basis of a driving signal for driving a first actuator moving the stage in the first direction and a disturbance correcting signal generated from a vibration transfer function in the second direction of the stage.

According to the third aspect, since the force applied to the stage is controlled on the basis of the disturbance correcting signal generated from the vibration transfer function in the second direction of the stage in addition to the driving signal for driving the first actuator moving the stage in the first direction, it is possible to prevent the adverse effect of the vibration of the stage generated after accelerating the stage in the first direction.

The force applied to the stage may be obtained, for example, by driving a second actuator for moving the stage in the second direction.

According to a fourth aspect of the invention, there is provided a stage control apparatus for controlling a stage which can move in at least a first direction and a second direction different from the first direction, including: a signal generator that generates a driving signal for driving a first actuator moving the stage in the first direction and a disturbance correcting signal generated from a vibration transfer function in the second direction of the stage; and a controller that controls a force applied to the stage on the basis of the driving signal and the disturbance correcting signal.

According to the fourth aspect, since the force applied to the stage is controlled on the basis of the disturbance correcting signal generated from the vibration transfer function in the second direction of the stage in addition to the driving signal for driving the first actuator moving the stage in the first direction, it is possible to prevent the adverse effect of the vibration of the stage generated after accelerating the stage in the first direction.

The force applied to the stage may be obtained by driving a second actuator for moving the stage in the second direction on the basis of the disturbance correcting signal.

According to a fifth aspect of the invention, there is provided an exposure method of performing an exposing operation using a stage holding a plate, wherein the stage is driven by the drive control method or the stage control method.

According to the fifth aspect, since the stage is driven using the stage control method which can prevent the adverse effect of the vibration of the stage generated after the stage is accelerated in the first direction, it is possible to prevent exposure precision from decreasing.

According to a sixth aspect of the invention, there is provided an exposure apparatus for performing an exposing operation using a stage holding a plate, including the drive control apparatus or the stage control apparatus.

According to the sixth aspect, since the stage is driven using the drive control apparatus or the stage control apparatus which can prevent the adverse effect of the vibration of the stage generated after the object or stage is accelerated in the first direction, it is possible to prevent exposure precision from decreasing.

According to a seventh aspect of the invention, there is provided a measurement apparatus including a stage on which a sample is placed and the stage control apparatus.

According to the seventh aspect, since the stage is driven using the stage control apparatus which can prevent the adverse effect of the vibration of the stage generated after the stage is accelerated in the first direction, it is possible to obtain measurement results with high reliability.

According to the above-mentioned configurations, it is possible to prevent the adverse effect of the vibration of a driving target.

### BRIEF DESCRIPTION OF THE DRAWINGS

FIG. 1 is a diagram schematically illustrating the configuration of an exposure apparatus according to an embodiment of the invention.

FIG. 2 is a sectional view illustrating a partial configuration of the exposure apparatus according to the embodiment of the invention.

FIG. 3 is a sectional view illustrating a partial configuration of the exposure apparatus according to the embodiment of the invention.

FIG. 4 is a block diagram illustrating the configuration of a control device according to the embodiment of the invention.

FIG. 5 is a diagram illustrating a dynamical system model.

### DESCRIPTION OF EMBODIMENTS

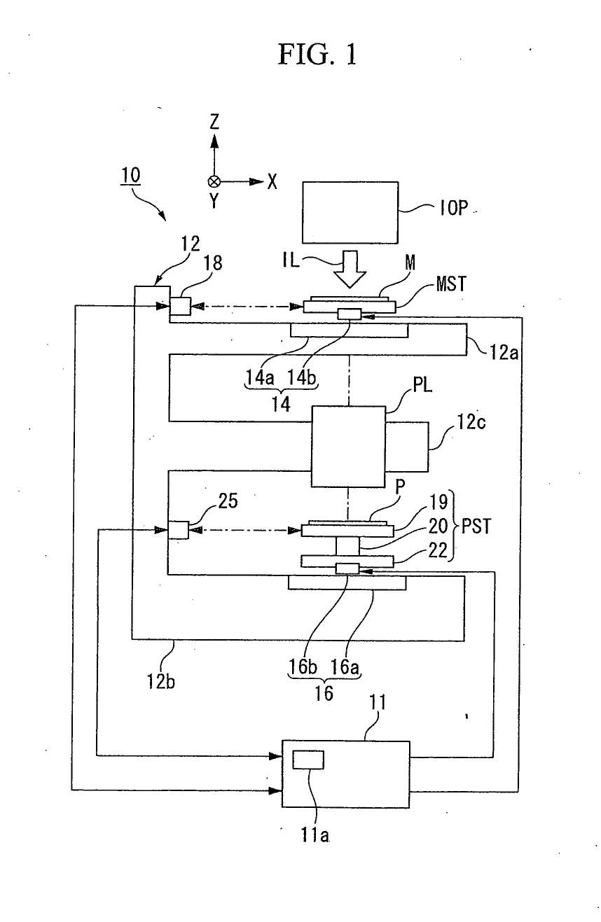

Hereinafter, an embodiment of the invention will be described with reference to the accompanying drawings. FIG. 1 is a diagram schematically illustrating the configuration of an exposure apparatus 10 according to an embodiment of the invention. The exposure apparatus 10 is an equal-magnification collective transfer type liquid crystal scanning exposure apparatus that scans a mask M having a liquid crystal display device pattern formed thereon and a glass plate (hereinafter, referred to as “plate”) P as a plate (and object) held on a plate stage PST as a first stage at the same speed in a first direction, that is, a predetermined scanning direction (which is the X axis direction (lateral direction in the paper surface) of FIG. 1, relative to a projection optical system PL and transfers the pattern formed on the mask M to the plate P.

The exposure apparatus 10 includes an illumination system IOP that illuminates a predetermined slit-like illumination area (a rectangular or arc-like area) extending thinly and longitudinally in the Y axis direction (direction perpendicular to the paper surface of FIG. 1) on the mask M with exposing illumination light IL, a mask stage MST as a second stage that holds the mask M having a pattern formed thereon and moves in the X axis direction, a projection optical system PL that projects the exposing illumination light IL passing through the illumination area of the mask M onto the plate P, a body column 12, an anti-vibration pedestal (not shown) that removes the vibration from a floor to the body column 12, and a control device (stage control device) 11 that controls the stages MST and PST.

For example, as disclosed in JP-A-9-320956, the illumination system IOP includes a light source unit, a shutter, a secondary-light-forming optical system, a beam splitter, a focusing lens system, a field diaphragm (blind), and an imaging lens system (none of which are shown), and illuminates the slit-like illumination area on the mask M placed and held on the mask stage MST to be described later with uniform intensity of illumination.

The mask stage MST is floatingly supported over the top surface of an upper platen 12a of the body column 12 with a clearance of several μm interposed therebetween by an air pad (not shown), and is driven in the X axis direction by a driving mechanism 14.

Since a linear motor is employed herein as the driving mechanism 14 driving the mask stage MST, the driving mechanism is hereinafter referred to as linear motor 14. The stator 14a of the linear motor 14 is fixed to the top of the upper platen 12a and extends in the X axis direction. A moving member 14b of the linear motor 14 is fixed to the mask stage MST. The position in the X axis direction of the mask stage MST is always measured with a predetermined resolution of, for example, several nanometer with respect to the projection optical system PL by a mask stage position measuring laser interferometer (hereinafter, referred to as “mask interferometer”) 18 fixed to the body column 12. X-axis position information S3 of the mask stage MST measured by the mask interferometer 18 is supplied to a main control device (drive control device, stage control device) 11.

The projection optical system PL is disposed below the upper platen 12a of the body column 12 and is held by a holding member 12c of the body column 12. A projection optical system projecting an equal-magnification erected image is used herein as the projection optical system PL. Accordingly, when the slit-like illumination area on the mask M is illuminated with the exposing illumination light IL from the illumination system IOP, an equal-magnification image (partial erected image) of a circuit pattern of the illumination area is projected to an exposure area on the plate P which is a conjugate of the illumination area. For example, as disclosed in JP-A-7-57986, the projection optical system PL may include plural sets of equal-magnification projection optical units.

In this embodiment, a focal position detector, which is not shown, measuring the position in the Z direction of the plate P, for example, an auto focus sensor (not shown) including a CCD or the like, is fixed to the holding member 12c holding the projection optical system PL. The Z-position information of the plate P from the focal position detector is supplied to the main control device 11. The main control device 11 performs an auto focusing operation of matching the Z position of the plate P with the imaging plane of the projection optical system PL on the basis of the Z-position information during the scanning exposure.

The plate stage PST is disposed below the projection optical system PL and is floatingly supported over the top of a lower platen 12b of the body column 12 with a clearance of several micrometer interposed therebetween by an air pad (not shown). The plate stage PST is driven in the X axis direction by the linear motor 16 as the driving mechanism.

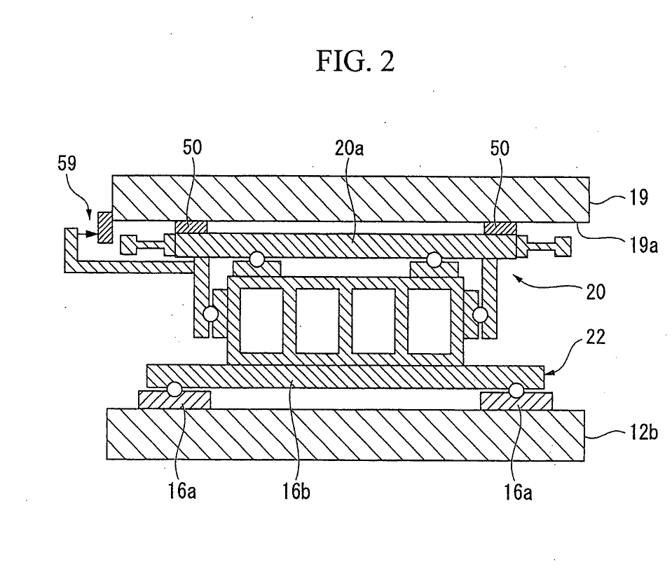

A stator 16a of the linear motor 16 is fixed to the lower platen 12b and extends in the X axis direction. A moving member 16b as a moving part of the linear motor 16 is fixed to the bottom of the plate stage PST. The plate stage PST includes a movable table 22 to which the moving member 16b of the linear motor 16 is fixed, an Y driving mechanism 20 mounted on the movable table 22, and an Y moving member 20a (see FIG. 2) disposed over the Y driving mechanism 20.

The position in the X axis direction of the plate table 19 is always measured with a predetermined resolution of, for example, several nanometer with respect to the projection optical system PL by a plate interferometer 25 fixed to the body column 12. A two-axis interferometer irradiating the plate table 19 with two length-measuring beams in the X axis direction separated by a predetermined distance L from each other in the Y axis direction (direction perpendicular to the paper surface of FIG. 1) perpendicular to the X axis direction is used as the plate interferometer 25, and the measured values of the length-measuring axes are supplied to the main control device 11.

When the measured values of the length-measuring axes of the plate interferometer 25 are X1 and X2, the position of the plate table 19 in the X axis direction can be calculated by X=(X1+X2)/2 and the amount of rotation of the plate table 19 about the Z axis can be calculated by θ=(X1−X2)/L. In the following description, it is assumed that the X is output as the X-position information S1 of the plate table 19 from the plate interferometer 25 if not particularly necessary.

In this embodiment, the linear motor 16 and the Y driving mechanism 20 constitute a first actuator. However, only the configuration for drive in the X axis direction may constitute the first actuator or only the configuration for drive in the Y axis direction may constitute the first actuator.

FIG. 2 is a sectional view illustrating the detailed configuration of the plate stage PST.

As shown in the drawing, a leveling unit 50 as a second actuator is disposed between the bottom surface (surface facing the −Z direction) 19a of the plate table 19 and the Y moving member 20a. Plural leveling units 50, for example, three leveling units, are provided and serve to control the posture (Z-direction position, θ_{X}-direction position, and θ_{Y}-direction position) of the plate table 19 by finely adjusting the Z-direction positions at three places of the plate table 19. That is, by applying a predetermined force to the plate table 19 by the use of the three leveling units 50 (second actuator), the Z-direction position, the θ_{X}-direction position, and the θ_{Y}-direction position of the plate table 19 can be adjusted.

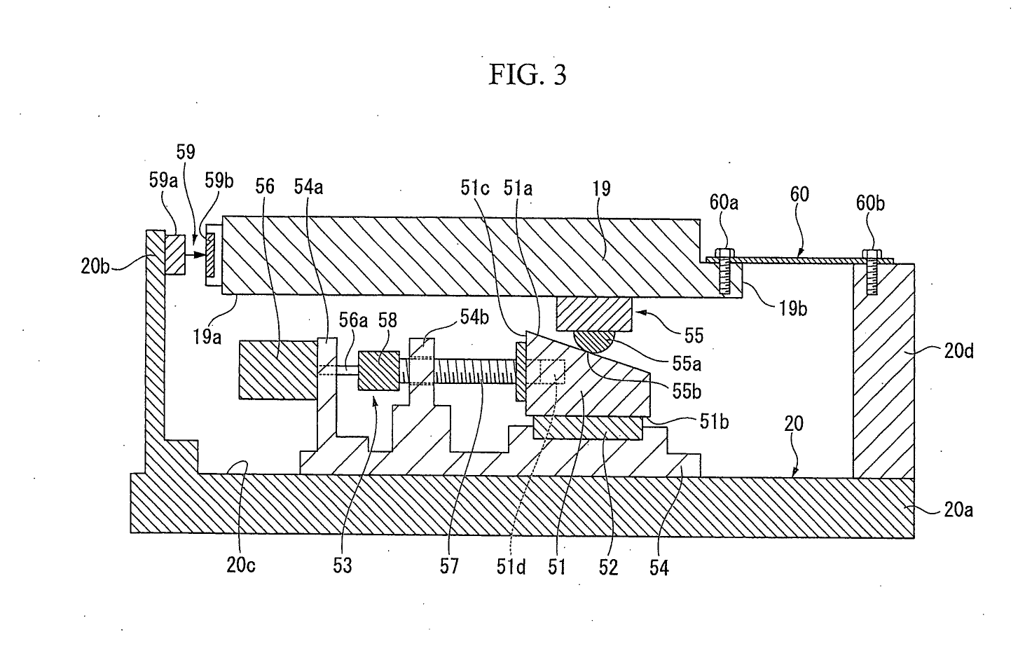

FIG. 3 is a diagram illustrating the configuration of the leveling unit 50. Each leveling unit 50 has the same configuration and thus one configuration thereof will be described.

The leveling unit 50 includes a cam member 51 disposed on the Y moving member 20a, a guide member 52, a cam moving mechanism 53, a support member 54, and a bearing member 55 disposed close to the plate table 19.

The cam member 51 is a member having a trapezoidal sectional shape, and the bottom surface 51a thereof is flat in the horizontal direction. The bottom surface 51a of the cam member 51 is supported by the guide member 52. The top surface 51b of the cam member 51 is a flat plane oblique about the horizontal plane. A screw hole 51d is formed in one side surface 51c of the cam member 51. The guide member 52 is disposed on the support member 54 along the cam member 51 and extends in the lateral direction of the drawing.

The cam moving mechanism 53 includes a servo motor 56, a ball screw 57, and a connecting member 58. The servo motor 56 rotates a shaft member 56a on the basis of a signal from the controller 11a. Here, the shaft member 56a extends, for example, in the lateral direction of the drawing. The ball screw 57 is connected to the shaft member 56a of the servo motor 56 via the connecting member 58 and is supplied with the rotation of the shaft member 56a. The ball screw 57 is provided with a screw portion in the lateral direction of the drawing (in the same direction as the axis direction of the rotation shaft of the servo motor 56) and the screw portion is screwed to the screw hole 51d formed on the side surface 51c of the cam member 51. The shaft member 56a and the ball screw 57 are supported by protrusions 54a and 54b of the support member 54, respectively.

In the cam moving mechanism 53, the ball screw 57 rotates with the rotation of the servo motor 56 and the cam member 51 screwed to the ball screw 57 moves in the lateral direction of the drawing along the guide member 52 with the rotation of the ball screw 57.

The bearing member 55 has a semi-spherical portion 55a under the bearing member in the drawing and the bottom surface 55b of the semi-spherical portion 55a comes in contact with the top surface 51b of the cam member 51. With the movement of the cam member 51, the contact position of the bottom surface 55b of the bearing member 55 and the top surface 51b of the cam member 51 varies. With the variation of the contact position with the top surface 51b, the Z-direction position of the bottom surface 55b varies. The Z-direction position of the plate table 19 is finely adjusted with the variation in position.

The Z-direction position of the plate table 19 is detected by a detector 59. Plural detectors 59, for example, three detectors, are disposed in the plate table 19. Each detector 59 includes, for example, an optical sensor 59a and a detection member 59b, and detects the Z-direction position of the detection member 59b by detecting the position of the detection member 59b by the use of the optical sensor 59a. The optical sensor 59a is fixed to a protrusion 20b disposed on the Y moving member 20a. Accordingly, the detector 59 can detect the position or posture of the plate table 19 relative to the top surface 20c of the Y moving member 20a. The position information detected by the detector 59 is sent to the main control device 11.

An end of the plate table 19 is connected to a protrusion 20d of the Y moving member 20a with an elastic member 60. One end of the elastic member 60 is fixed to an end portion 19b of the plate table 19 with a fixing member 60a and the other end is fixed to the protrusion 20d with a fixing member 60b. By this elastic member 60, it is possible to suppress the plate table 19 from moving in the X axis direction and the Y axis direction and to allow the movement in the Z axis direction.

By this configuration, the plate stage PST can move (positions in the X axis direction) the movable table 22 (the moving member of the linear motor 16) in the X axis direction and can move (position in the Y axis direction) the Y moving member 20 in the Y axis direction with respect to the movable table 22, so that a predetermined area to be exposed on the plate P held by the plate table 19 is located at the exposure area of the projection optical system PL. At this time, the θ_{Z}-direction position of the plate P may be adjusted. The leveling units 50 (second actuator) can move the plate table 19 (position in the Z axis direction, the θ_{X} direction, and the θ_{Y} direction) in the Z axis direction, the θ_{X} direction, and the θ_{Y} direction with respect to the Y moving member 20a on the basis of the detection result of the auto focus sensor, so that the Z-direction position of the plate P is located at a just-focused position (which is matched with the imaging point of the projection optical system PL).

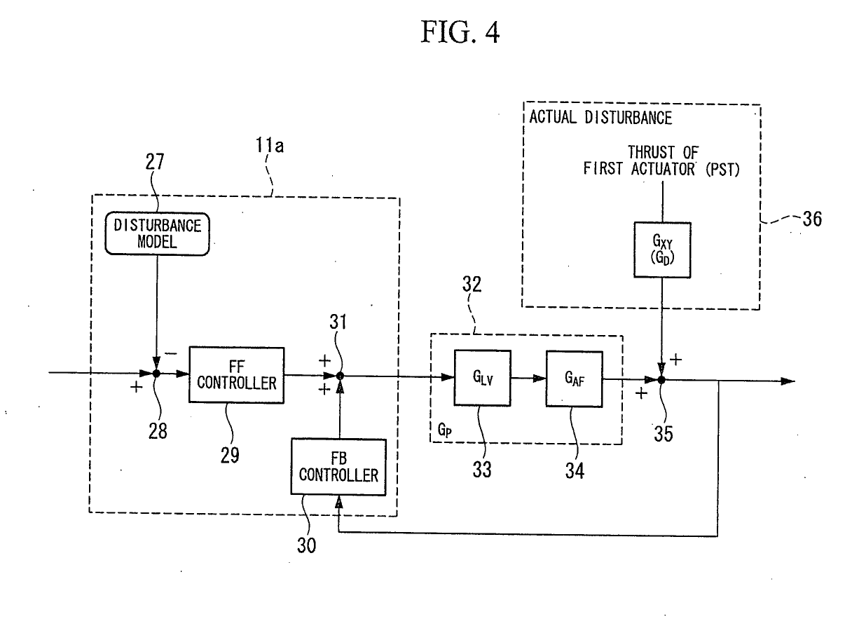

The configuration of the controller 11a, which is involved in driving the plate stage PST, in the main control device 11 will be described with reference to FIG. 4. FIG. 4 is a block diagram illustrating the controller 11a and a control target thereof.

The controller 11a is a device controlling a control target 32 represented by a transfer function G_{P} and includes a computing unit 28, a perfect tracking FF (Feed Forward) controller 29, a FB (Feed Back) controller 30, and a computing unit 31. A disturbance model signal (disturbance correcting signal) 27 input to the computing unit 28 is prepared by the main control device 11, but a disturbance model signal prepared by another device may be stored in the main control device 11.

The control target 32 in this embodiment includes a control target 33 represented by a transfer function G_{LV} and a control target 34 represented by a transfer function G_{AF}. The control target 33 includes the leveling units 50 and the control systems (feedback control systems) thereof. The position of the plate table 19 is controlled on the basis of the relative position of the optical sensor 59a and the detection member 59b detected by the detector 59. The control target 34 represents the entire position (including the vibration in the Z axis direction) of the plate stage PST.

The output terminal of the control target 32 is affected by a disturbance 36 (which is illustrated as the computing unit 35). The disturbance 36 is caused by the thrust applied to the plate stage PST when the plate stage PST in the just-focused state is accelerated and moved by the first actuator. The controller 11a includes a control system for the plate stage PST and a control system for the mask stage MST (not shown).

The disturbance model signal 27 is a model signal generated in advance on the basis of the disturbance 36. Examples of the disturbance 36 include force, acceleration, speed, and displacement in the Z axis direction. The values thereof are measured and the model signal is generated on the basis of the measurement results. For example, a model signal obtained by preparing an algebraic disturbance model based on a physical model and estimating and evaluating parameters thereof using a batch least square method is used. A disturbance model signal prepared using a physical model in the form of transfer function or state equation or a black box model may also be used. Two or more of force, acceleration, speed, and displacement may be combined to generate a disturbance model signal.

For example, the disturbance model signal 27 is generated on the basis of a circuit expressed by a transfer function G_{D} (transfer function G_{XY} expressed by Expression 1 in this embodiment). In Expression 1, ωₚ represents a resonance frequency, represents a resonance attenuation coefficient, ω_{z} represents an antiresonance frequency, ζ_{z} represents an antiresonance attenuation coefficient, and k_{f} represents a gain coefficient.

$${G}_{XY} ( s ) = k \frac{{s}^{2} + 2 {ζ}_{z} {ω}_{z} s + {ω}_{z}^{2}}{{s}^{2} + 2 {ζ}_{p} {ω}_{p} s + {ω}_{p}^{2}} \qquad ( 1 )$$

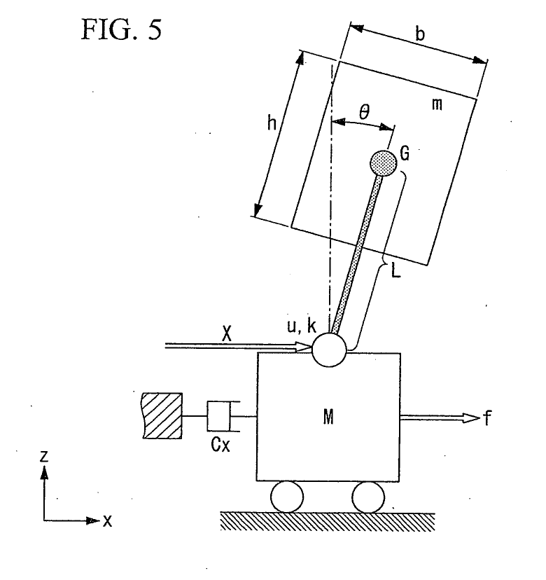

Since the plate stage PST shown in FIG. 2 can be expressed by a dynamical system model shown in FIG. 5, the disturbance model can be expressed by Expression 2.

$$\frac{θ}{f} = \frac{es}{{as}^{3} + {bs}^{2} + cs + d} \qquad ( 2 )$$

Here, a=MmL+I_{y}(M+m), b=(M+m)μ+(I_{y}+ML²)Cₓ, c=(k−mgL)(M+m)+Cₓμ, d=Cₓ(k−mgL), and e=−Lm M represents the mass of the first stage, m represents the mass of the second stage, I_{y} represents the moment of inertia about the center of the second stage, L represents the distance between the rotation center of the rotational movement of the second stage and the center of the second stage, μ represents the attenuation coefficient between the first stage and the second stage, k represents the torsional stiffness between the first stage and the second stage, and g represents the gravitational acceleration. In this case, the first stage corresponds to the X stage and includes the stator 16a and the moving member 16b of the linear motor and the Y stator (not shown) of the Y driving mechanism 20. The second stage corresponds to the Y stage and includes the Y moving member 20a, the plate table 19, the leveling units 50, and the detectors 59.

The disturbance model signal 27 predicts the influence of the disturbance (mainly the variation in Z-direction position of the plate P due to the vibration) caused at the time of driving the plate stage PST by the use of the first actuator and moves the plate table 19 in the reverse phase (the phase obtained by reversing a sign of a signal) in the Z axis direction. That is, even when a vibration in the Z axis direction occurs in the plate P on the plate table 19, the exposure area (focusing area) of the plate P tracks the imaging point of the projection optical system PL by predicting the vibration and driving the second actuator. By changing the gain from the original component at the time of calculating the reverse phase, it may be possible to adjust, for example, the degree of tracking.

The computing unit 28 subtracts the disturbance model signal 27 generated as described above and outputs the result.

The perfect tracking FF controller 29 and the FB controller 30 are circuits converting a low-frequency signal including the disturbance model signal into a high-frequency signal by the perfect tracking control. Examples of the perfect tracking control include a single-rate control or a multi-rate control (for example, see JP-A-2001-325005 and “Perfect Tracking Method using Multi-rate Feed Forward Control”, paper written by Hiroshi FUJIMOTO, etc., Society of Instrument and Control Engineers, vol. 36, No. 9, pp 766-772, 2000). The output of the computing unit 28 is sent to the computing unit 31 via the perfect tracking FF controller 29. The output (for example, the movement of the plate stage PST detected by the plate interferometer 25 or the optical sensor 59a, or the auto focus sensor) of the control target 32 is sent to the computing unit 31 via the FB controller 30. The computing unit 31 adds the output of the perfect tracking FF controller 29 and the output of the FB controller 30 and outputs the result to the control target 32. In this embodiment, the difference from a target value which cannot be completely removed by the perfect tracking FF controller 29 is fed back and removed by the FB controller 30.

The exposing operation of the exposure apparatus 10 will be described mainly with reference to the motion of the plate stage PST.

When the exposing operation is started, the main control device 11 outputs a control signal to a plate carrying apparatus not shown so as to carry and hold the plate P onto the plate table 19, and outputs a control signal to a mask carrying apparatus not shown so as to carry and hold the mask M. The main control device 11 moves the mask stage MST in synchronization with the movement of the plate stage PST, and sequentially transfers parts of the pattern formed on the mask M to the shot areas of the plate P with the movement of the plate stage PST and the mask stage MST. At this time, whenever the transfer of the pattern to one shot area is finished, the plate stage PST and the mask stage MST are moved by a step and the pattern is transferred onto another shot area. When the transfer of the pattern onto all the shot areas is finished, the exposing operation is finished. Here, the difference results from the fact that the disturbance model does not accurately reflect the disturbance 36 or the fact that an irregular disturbance such as earthquake which is not considered by the disturbance model occurs.

When it is intended to drive the plate stage PST in the course of the exposing operation, the position control of the plate table 19 in the Z axis direction is carried out. In this control, the computing unit 28 of the controller 11a subtracts the disturbance model signal 27. The output signal of the computing unit 28 is converted into a high-frequency signal of, for example, about 3 kHz by the perfect tracking FF controller 29 and is then input to the computing unit 31. The computing unit 31 adds the output signal converted into a high-frequency signal by the FB controller 30 to the output signal of the perfect tracking FF controller 29 and outputs the resultant signal.

The control signal from the controller 11a is input to the control target 32, and the control target 33 and the control target 34 are controlled. Only the control based on the positional relation of the optical sensor 59a of the detector 59 and the detection member 59b is carried out in the control target 32, but the position control in the X axis direction (and/or the Y axis direction) of the plate stage PST or the position control (for example, the auto focusing operation of the focal position detector on the imaging point of the projection optical system PL) in the Z axis direction of the plate table 19 is carried out by adding the control in the control target 34 thereto.

When the plate stage PST is accelerated in the X axis direction (or the Y axis direction), the vibration in the Z axis direction is caused in the whole plate stage PST due to the acceleration. On the other hand, a movement component in the reversed phase of the vibration in the Z axis direction of the plate stage PST is applied to the plate table 19 having the plate P placed thereon by the control of the controller 11a. Accordingly, the leveling units 50 (the second actuator) can be driven so that the exposure area of the plate P always tracks the imaging point of the projection optical system PL. At this time, the focal position detector detects that the plate stage PST is stationary in the Z axis direction.

At this time, the value of the output terminal of the control target 32 may be monitored and it may be determined whether a difference from the target value exists. When it is determined that a difference exists between the control value and the target value, it is preferable that the main control device 11 performs a driving operation while properly correcting the resonance frequency, the resonance attenuation coefficient, the antiresonance frequency, the antiresonance attenuation coefficient, and the gain coefficient of the transfer function G_{XY}. When the transfer function optimal for the driving can be obtained by properly correcting the coefficients, for example, the obtained coefficients may be set as initial values in the next time and then the exposing operation may be performed.

In this embodiment, since the force applied to the plate stage PST is controlled on the basis of the disturbance model signal 27 generated from the transfer function of the vibration in the Z axis direction of the plate stage PST, it is possible to prevent the adverse effect of the vibration of the plate stage PST generated after the plate stage PST is accelerated.

Although the embodiment of the invention has been described, the invention is not limited to the embodiment but may be modified in various forms within the scope of the invention.

For example, the second actuator (the leveling units) applying the force to the plate table 19 is not limited to the above-mentioned configuration. For example, an actuator such as a voice coil motor or an electromagnet in which a moving member and a fixed member do not come in contact with each other may be used or an actuator in which a moving member and a fixed member come in contact with each other like this embodiment may be used. The force may be applied to the plate table 19 by an element other than the second actuator.

Although it has been described in the embodiment that the invention is applied to the equal-magnification collective transfer type liquid crystal scanning exposure apparatus, the invention is not limited to the embodiment. The invention may be applied to exposure apparatuses such as a stepper for manufacturing a semiconductor device or a scanning stepper as well as a step-and-repeat type liquid crystal stepper or a step-and-scan type liquid crystal scanning stepper. The invention may be also applied to a vertical exposure apparatus in which the mask M and the plate P are held in the vertical direction.

The stage control device according to the invention may be also applied to an apparatus having a plate stage holding a plate and moving, such as a laser repair apparatus as well as exposure apparatuses such as an electron beam exposure apparatus and an X-ray exposure apparatus.

The invention may be also applied to the driving of apparatuses having a moving stage as well as the exposure apparatus. An example of such an apparatus is a measurement apparatus that includes a stage having a sample place thereon and measures the shape of the sample. By applying the invention to the measurement apparatus, it is possible to perform a measuring operation with high reliability. The invention may be applied to the driving of information products such as an optical disk or a magnetic disk, the driving of arms of machine tools and the like, the driving of robots, the driving of vehicles, and the driving of other instruments or apparatuses.

In such apparatuses, for example, disturbance to be considered is assumed and a disturbance model signal is generated in advance on the basis of the disturbance. By causing the apparatuses to move in the reversed phase of the disturbance applied at the time of driving, it is possible to suppress the influence of the disturbance.

Examples of the plate P include a glass substrate for a display device, a semiconductor wafer for manufacturing a semiconductor device, a ceramic wafer for a thin-film magnetic head, a mask or a reticle plate (synthesized quartz or silicon wafer) used to an exposure apparatus, and a film member. The shape of the plate is not limited to a rectangle, but may be other shapes such as a circle.

A step-and-scan type scanning exposure apparatus (scanning stepper) that synchronously moves a mask M and a plate P and scans and exposing the pattern of the mask M or a step-and-repeat type projection exposure apparatus (stepper) that collectively exposes the pattern of a mask M in a state where the mask M and a plate P are stopped and sequentially moves the plate P step by step may be used as the exposure apparatus 10.

In the step-and-repeat type exposure, a reduced image of a first pattern may be transferred onto the plate P using a projection optical system in a state where the first pattern and the plate P are almost stopped, and then a reduced image of a second pattern may be transferred onto the plate P so as to partially overlap with the first pattern in a state where the second pattern and the plate P are almost stopped (stitch type full-field exposure apparatus). Regarding stitch type exposure, the invention may be applied to a step- and stitch type exposure apparatus that transfers at least two patterns onto a plate P so as to partially overlap with each other and sequentially moves the plate P.

For example, as disclosed in U.S. Pat. No. 6,611,316, the invention may be applied to an exposure apparatus that synthesizes two mask patterns on a plate using a projection optical system and double-exposes one shot area on the plate almost at a time by one scanning exposure.

The invention may be applied to a twin stage type exposure apparatus having plural plate stages, as disclosed in U.S. Pat. No. 6,341,007, U.S. Pat. No. 6,400,441, U.S. Pat. No. 6,549,269, U.S. Pat. No. 6,590,634, U.S. Pat. No. 6,208,407, and U.S. Pat. No. 6,262,796.

For example, as disclosed in JP-A-11-135400 (PCT Publication No. 1999/23692) and U.S. Pat. No. 6,897,963, the invention may be applied to an exposure apparatus including a plate stage holding a plate and a measurement stage mounted with a reference member having a reference mark formed thereon and/or various photoelectric sensors. The invention may be also applied to an exposure apparatus including plural plate stages and measurement stages.

The type of the exposure apparatus 10 is not limited to the exposure apparatus for manufacturing a liquid crystal display or a display, but the invention may be widely applied to an exposure apparatus for manufacturing a semiconductor device in which a plate is exposed with a semiconductor device pattern and exposure apparatuses for manufacturing a thin-film magnetic head, an imaging device (CCD), a micro machine, an MEMS, a DNA chip, and a reticle or mask.

Although the exposure apparatus including the projection optical system PL has been exemplified in the above-mentioned embodiment, the invention may be applied to an exposure apparatus and an exposure method not using the projection optical system PL. When the projection optical system PL is not used in this way, the exposing light EL is applied to a plate via an optical member such as a lens.

In the above-mentioned embodiment, the exposure apparatus 10 is manufactured by assembling various sub systems having elements so as to maintain predetermined mechanical precision, electrical precision, and optical precision. To guarantee the variety of precision, various optical systems are adjusted to accomplish the optical precision, various mechanical systems are adjusted to accomplish the mechanical precision, and various electrical systems are adjusted to accomplish the electrical precision, before and after the assembly. The process of assembling an exposure apparatus from various sub systems includes mechanically connecting various sub systems, electrically connecting electrical circuits, and connecting pneumatic circuits. Of course, processes of assembling the respective sub systems are carried out before the process of assembling an exposure apparatus from various sub systems. When the process of assembling an exposure apparatus from various sub systems is finished, a general coordination is performed to guarantee a variety of precision of the exposure apparatus as a whole. The exposure apparatus is preferably manufactured in a clean room where the temperature, the cleanness, and the like are managed.

A micro device such as a semiconductor device is manufactured through a step of designing functions and performance of the micro device, a step of manufacturing a mask (reticle) based on the designing step, a step of manufacturing a plate as a substrate of the device, a plate processing step including a plate process (exposing process) of exposing the plate with a pattern image of the mask and developing the exposed plate according to the above-mentioned embodiment, a device assembling step (including processes such as a dicing process, a bonding process, and a package process), and an inspection step.

As far as is permitted, the descriptions of all the documents cited in the embodiments and the modified examples may be incorporated herein by reference.

While the embodiments of the invention have been described above, the invention may be embodied by properly combining all the above-mentioned elements or may be embodied without using some elements.

1. A drive control method of controlling an object which can move in at least a first direction and a second direction different from the first direction,
wherein a force applied to the object is controlled on the basis of a driving signal for driving a first actuator moving the object in the first direction and a disturbance correcting signal generated from a disturbance in the second direction of the object.

2. The drive control method according to claim 1,
wherein the disturbance includes a position variation component in the second direction generated when the object is driven by the first actuator,
and wherein the disturbance correcting signal enables the object to move in the second direction with a reverse phase of the position variation component.

3. The drive control method according to claim 1, wherein a perfect tracking control is carried out on the disturbance correcting signal.

4. The drive control method according to claim 3, wherein the perfect tracking control is a single-rate control.

5. The drive control method according to claim 3, wherein the perfect tracking control is a multi-rate control.

6. A drive control apparatus for controlling an object which can move in at least a first direction and a second direction different from the first direction, comprising:
a signal generator that generates a driving signal for driving a first actuator moving the object in the first direction and a disturbance correcting signal generated on the basis of a disturbance in the second direction of the object; and
a controller that controls a force applied to the object on the basis of the driving signal and the disturbance correcting signal.

7. The drive control apparatus according to claim 6, wherein the disturbance includes a position variation component in the second direction generated when the object is driven by the first actuator and the disturbance correcting signal enables the object to move in the second direction with a reverse phase of the position variation component.

8. The drive control apparatus according to claim 6, wherein a perfect tracking control is carried out on the disturbance correcting signal.

9. The drive control apparatus according to claim 8, wherein the perfect tracking control is a single-rate control.

10. The drive control apparatus according to claim 8, wherein the perfect tracking control is a multi-rate control.

11. A stage control method of controlling a stage which can move in at least a first direction and a second direction different from the first direction,
wherein a force applied to the stage is controlled on the basis of a driving signal for driving a first actuator moving the stage in the first direction and a disturbance correcting signal generated from a vibration transfer function in the second direction of the stage.

12. The stage control method according to claim 11,
wherein the transfer function includes a position variation component in the second direction generated when the stage is driven by the first actuator,
and wherein the disturbance correcting signal enables the stage to move in the second direction with a reverse phase of the position variation component.

13. The stage control method according to claim 11, wherein the transfer function is expressed by an expression:
$${G}_{XY} ( s ) = k \frac{{s}^{2} + 2 {ζ}_{z} {ω}_{z} s + {ω}_{z}^{2}}{{s}^{2} + 2 {ζ}_{p} {ω}_{p} s + {ω}_{p}^{2}}$$
(where ωₚ represents a resonance frequency, ζₚ represents a resonance attenuation coefficient, ω_{z} represents an antiresonance frequency, ζ_{z} represents an antiresonance attenuation coefficient, and k_{f} represents a gain coefficient).

14. The stage control method according to claim 11, wherein the force is controlled by driving a second actuator that moves the stage in the second direction.

15. The stage control method according to claim 14, wherein a plurality of the second actuators are provided and the stage is controlled to have a predetermined posture in the second direction by the second actuators.

16. The stage control method according to claim 11, wherein the driving signal includes acceleration information in the first direction of the stage and the stage is controlled so that a predetermined position of the stage reaches a target position.

17. The stage control method according to claim 13, wherein the stage is controlled while correcting at least one of the resonance frequency, the resonance attenuation coefficient, the antiresonance frequency, the antiresonance attenuation coefficient, and the gain coefficient of the disturbance correcting signal.

18. The stage control method according to claim 13, wherein the disturbance correcting signal is set in advance by controlling the stage while correcting at least one of the resonance frequency, the resonance attenuation coefficient, the antiresonance frequency, the antiresonance attenuation coefficient, and the gain coefficient.

19. The stage control method according to claim 11, wherein a perfect tracking control is carried out on the disturbance correcting signal.

20. The stage control method according to claim 19, wherein the perfect tracking control is a single-rate control.

21. The stage control method according to claim 19, wherein the perfect tracking control is a multi-rate control.

22. A stage control apparatus for controlling a stage which can move in at least a first direction and a second direction different from the first direction, comprising:
a signal generator that generates a driving signal for driving a first actuator moving the stage in the first direction and a disturbance correcting signal generated from a vibration transfer function in the second direction of the stage; and
a controller that controls a force applied to the stage on the basis of the driving signal and the disturbance correcting signal.

23. The stage control apparatus according to claim 22, wherein the transfer function includes a position variation component in the second direction generated when the stage is driven by the first actuator and the disturbance correcting signal enables the stage to move in the second direction with a reverse phase of the position variation component.

24. The stage control apparatus according to claim 22, further comprising a memory that stores the disturbance correcting signal.

25. The stage control apparatus according to claim 22, wherein the transfer function is expressed by an expression:
$${G}_{XY} ( s ) = k \frac{{s}^{2} + 2 {ζ}_{z} {ω}_{z} s + {ω}_{z}^{2}}{{s}^{2} + 2 {ζ}_{p} {ω}_{p} s + {ω}_{p}^{2}}$$
(where ωₚ represents a resonance frequency, ζₚ represents a resonance attenuation coefficient, ω_{z} represents an antiresonance frequency, ζ_{Z} represents an antiresonance attenuation coefficient, and k_{f} represents a gain coefficient).

26. The stage control apparatus according to claim 22, wherein the controller drives a second actuator that moves the stage in the second direction on the basis of the disturbance correcting signal.

27. The stage control apparatus according to claim 26, wherein a plurality of the second actuators are provided and the controller controls the stage to have a predetermined posture in the second direction by the second actuators.

28. The stage control apparatus according to claim 22, wherein the driving signal includes acceleration information in the first direction of the stage and the controller controls the stage so that a predetermined position of the stage reaches a target position.

29. The stage control apparatus according to claim 23, wherein the controller drives the stage while correcting at least one of the resonance frequency, the resonance attenuation coefficient, the antiresonance frequency, the antiresonance attenuation coefficient, and the gain coefficient of the disturbance correcting signal.

30. The stage control apparatus according to claim 23 wherein the disturbance correcting signal is set in advance by controlling the stage while correcting at least one of the resonance frequency, the resonance attenuation coefficient, the antiresonance frequency, the antiresonance attenuation coefficient, and the gain coefficient.

31. The stage control apparatus according to claim 22, wherein the controller carries out a perfect tracking control on the disturbance correcting signal.

32. The stage control apparatus according to claim 31, wherein the perfect tracking control is a single-rate control.

33. The stage control apparatus according to claim 31, wherein the perfect tracking control is a multi-rate control.

34. An exposure method of performing an exposing operation using a stage holding a plate,
wherein the stage is driven by the drive control method according to claim 1.

35. A device manufacturing method having a lithography process,
wherein the exposure method according to claim 34 is used in the lithography process.

36. An exposure apparatus for performing an exposing operation using a stage holding a plate, comprising the drive control apparatus according to claim 6.

37. A device manufacturing method having a lithography process,
wherein the exposure apparatus according to claim 36 is used in the lithography process.

38. A measuring apparatus comprising:
a stage on which a sample is placed; and
the drive control apparatus according to claim 6.
